(19) United States
(12) Patent Application Publication
(10) Pub. No.: US 2010/0223119 A1
(43) Pub. Date: Sep. 2, 2010

(54) Advertising Through Product Endorsements in Social Networks

(75) Inventor: Aaron J. Klish, St. Joseph, IL (US)

Correspondence Address: MPG, LLP AND YAHOO! INC., 710 LAKEWAY DRIVE, SUITE 200, SUNNYVALE, CA, 94085, US

(73) Assignee: Yahoo! Inc., Sunnyvale, CA (US)

(21) Appl. No.: 12/396,301

(22) Filed: Mar. 2, 2009

(51) Int. Cl. G06Q 30/00

(52) U.S. Cl. 705/14.26

(57) ABSTRACT

Systems, methods and computer programs for creating a web user interface promoting products or service providers are provided. The method includes the creation of a library of products and service providers. Endorsements for products and service providers are generated by users of a social network that includes a social web site. The users create rules for sharing the endorsements with other users in the social web site or beyond the social web site. The user interface is built for a particular one of the users in the social web site, where the user interface includes a representation of the product or service provider associated with the endorsements. The user interface is created according to rules from the user that generated the object, rules by the user viewing the endorsement, and rules by a sponsor of the product or service provider associated with the endorsement. The user interface is then shown in a display.

### CROSS REFERENCE TO RELATED APPLICATIONS

This application is related to U.S. patent application Ser. No. 12/059711, filed Mar. 31, 2008, and entitled “Access to Trusted User-Generated Content Using Social Networks”, which is incorporated herein by reference.

### BACKGROUND

1. Field of the Invention

The present invention relates to methods for creating web user interfaces in a social web site, and more particularly, to methods, systems, and computer programs for creating advertising web user interfaces in a social web site.

2. Description of the Related Art

A social network service focuses on building online communities of people who share interests or activities, or who are interested in exploring the interests and activities of others. Most social network services are web based and provide a variety of ways for users to interact, such as e-mail and instant messaging services.

Social networking has created new ways to communicate and share information. Social networking websites are being used regularly by millions of people, and it now seems that social networking will be an enduring part of everyday life. The main types of social networking services are those which contain directories of some categories (such as former classmates), means to connect with friends (usually with self-description pages), and recommender systems linked to trust. Some of the most popular social networks in North America include, MYSPACE™, FACEBOOK™, and LINKEDIN™.

On one hand, the providers of social networks have the challenge of generating revenue to keep the social web sites running and to make a profit. On the other hand, internet advertisers are always searching for better ways to reach potential customers. It is in this context that embodiments of the invention arise.

### SUMMARY

Embodiments of the present invention provide methods, systems and computer programs for creating a web user interface promoting products or service providers. It should be appreciated that the present invention can be implemented in numerous ways, such as a process, an apparatus, a system, a device or a method on a computer readable medium. Several inventive embodiments of the present invention are described below.

In one embodiment, a method for creating a web user interface is presented. The method includes an operation for creating a library of products and service providers. In another operation, an endorsement object for a product or a service provider in the library is generated by a user of a social web site. Rules are obtained from the user for sharing the endorsement object with other users in the social web site. In another operation, a user interface is build for a particular one of the other users. The user interface includes a representation of the product or service provider associated with the endorsement object. The representation is made according to the defined rules and to endorsement viewing rules for the particular user. The user interface is visually depicted on a display. In another embodiment, a computer program implements the method.

In yet another embodiment, a system for creating a web user interface promoting products or service providers is presented. The system includes a social web server, and advertising server, and an endorsement server. The advertising server contains a library of products and service providers. The endorsement server contains endorsement objects for product and service providers in the library, where the endorsement objects are generated by users of a social web site. The endorsement objects have rules for sharing the endorsement object with other users in the social web site or beyond the social web site. The social web server includes a user interface for a particular user that includes a representation of a particular product or service provider associated with a particular endorsement object. The representation is made according to the rules for sharing and according to endorsement viewing rules for the particular user. The user interface is visually depicted on a display.

Other aspects of the invention will become apparent from the following detailed description, taken in conjunction with the accompanying drawings, illustrating by way of example the principles of the invention.

### BRIEF DESCRIPTION OF THE DRAWINGS

The invention may best be understood by reference to the following description taken in conjunction with the accompanying drawings in which:

FIG. 1 depicts a simplified schematic diagram of a network system for implementing embodiments of the present invention.

FIG. 2 illustrates the use of product endorsements in a social web site, according to one embodiment.

FIG. 3 depicts the relationships between the servers and the user, according to one embodiment.

FIG. 4 depicts a simplified representation of an embodiment for the data structures used to share product endorsements.

FIG. 5 is a pictorial representation of a user web page that includes product and service provider endorsements, according to one embodiment.

FIG. 6 shows a user interface for making endorsements, according to one embodiment.

FIG. 7A depicts a search user interface, according to one embodiment.

FIG. 7B depicts an embodiment of a user interface for viewing endorsements.

FIG. 8 illustrates a product endorsement page in accordance with one embodiment of the invention.

FIG. 9 shows a page of the user interface for displaying accumulated incentives, according to one embodiment.

FIG. 10 shows the flow of an algorithm for creating a web user interface in accordance with one embodiment of the invention.

FIG. 11 is a simplified schematic diagram of a computer system for implementing embodiments of the present invention.

### DETAILED DESCRIPTION

The following embodiments describe systems, methods and computer programs for creating a web user interface promoting products or service providers. The method includes the creation of a library of products and service providers. Endorsements for products and service providers are generated by users of a social network that includes a social web site. The users create rules for sharing the endorsements with other users in the social web site or beyond the social web site. The user interface is built for a particular one of the users in the social web site, where the user interface includes a representation of the product or service provider associated with the endorsements. The user interface is created according to rules from the user that generated the object, rules by the user viewing the endorsement, and rules by a sponsor of the product or service provider associated with the endorsement. The user interface is then shown in a display.

Embodiments of the invention provide for increasing advertisement revenue on social networking websites, matching relevant advertisements with social networking content, increasing traffic on social networking websites, creating a new advertising marketplace, learning about new products and services, identifying click spam to prevent abuse in the system, etc.

It will be obvious, however, to one skilled in the art, that the present invention may be practiced without some or all of these specific details. In other instances, well known process operations have not been described in detail in order not to unnecessarily obscure the present invention.

A typical social networking website consists of the following elements:

(1) A user home page with content created by an individual user.

(2) A method to exchange messages among users.

(3) A network of friends and associates for each individual user.

(4) A way to link from the user's home page to each friend's home page.

(5) A method to search for users and browse their home pages.

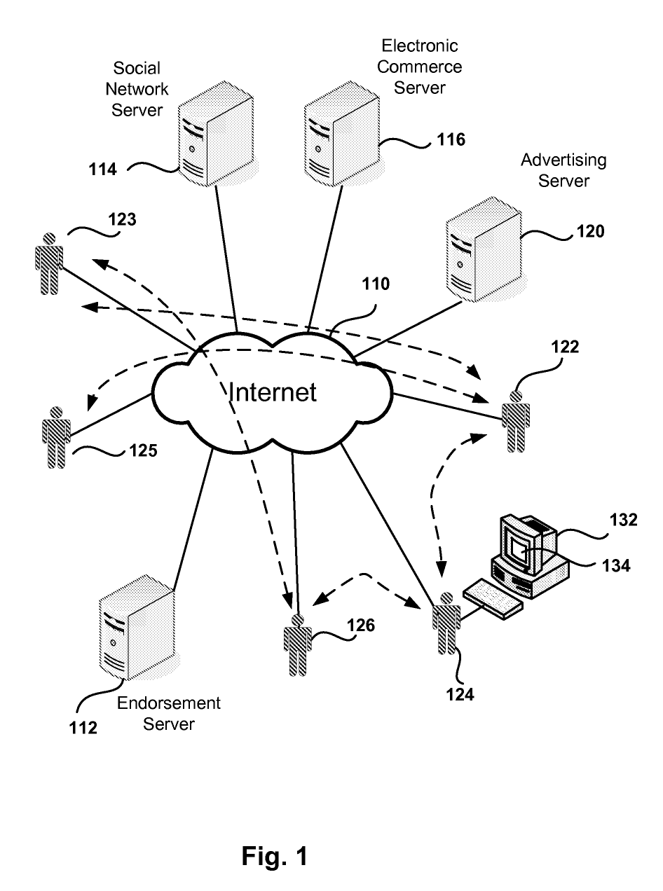

FIG. 1 depicts a simplified schematic diagram of a network system for implementing embodiments of the present invention. Internet 110 is used to interconnect users with servers. Users 122-126 access the Internet 110 via a variety of the devices, such as PC 132, laptops, mobile phones, etc. These are merely examples, and any other device used to access Internet 110 can be used to implement embodiments of this invention. For example, the devices may be wired or wireless. In one embodiment, a browser 134 is executed on a device, and the graphical user interface is presented on a display. Browser 134 provides the functionality for accessing the Internet.

Social Network Server 114 hosts a social network site available on Internet 110. Each social site can be hosted by one or more Social Network Servers. In the example of FIG. 1, users 122-126 belong to the social network hosted by social network server 114, and the users create relationships on the social network that link them to each other. A few sample relationships are shown in FIG. 1 by the dotted arrows joining user 122 to users 123-125; user 124 to users 122 and 126; user 126 to 123 and 124; etc. There is an abundance of social networking websites today, but little has been done to capitalize on the unique elements of social networking that are natural fits for advertising. The special relationship between the users in social networks provide unique opportunities for targeting and placing marketing messages in the social website based on these relationships.

Advertising server 120 provides ad delivery to Internet users and publishers, also referred to as content providers. An Internet ad is a commercial message in one of several formats, such as graphical or rich media. Today there are already many established relationships between advertisers and content providers. For example, popular bloggers can make money from their blogs through advertisement placed in their blog pages. Advertisers are willing to pay content providers for attracting users to their websites, increasing brand name recognition, selling their products or services, etc.

Endorsement Server 112 allows users in a social network to endorse products and services to friends in the social network, and sometimes to a wider circle of users outside their direct friends or outside the social network. Electronic Commerce Server 116 allows users to purchase products and services on the Internet. For example, once a user clicks on a product sponsored on a social site, the user is redirected to Electronic Commerce Server 116 where the user can purchase the sponsored product or service. Social Network Server 114, Advertising Server 120, Endorsement Server 112, and Electronic Commerce Server 116 cooperate to allow users to endorse products and services, get or search endorsement information from other users, place advertisements in social web sites, and purchase products and services.

Although different servers are described by way of example, the person skilled in the art will appreciate that multiple configurations are possible by combining several servers into one system, by having distributed systems where a single function can be accomplished by a plurality of different servers scattered across the Internet, or by caching information from the different databases at the different servers to accelerate the processing of information.

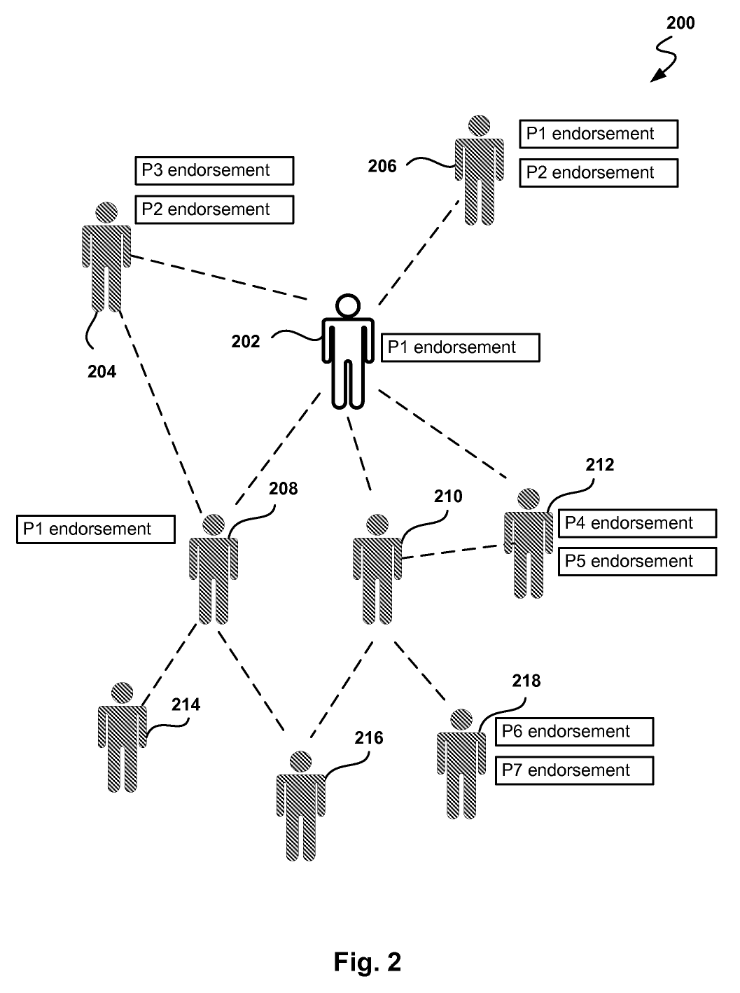

FIG. 2 illustrates the use of product endorsements in a social web site, according to one embodiment. Users in FIG. 2 belong to the same social network. A line connecting two users indicates that a relationship as been established between the two users connected. Sometimes, when two users are “connected” the two users are referred to as friends, although other terms can be used, such as contacts, associates, etc. Users can form associations, which are usually called groups (not shown). Examples of groups or organizations include church, tournament participants, book club, political party, family reunion, employees, etc.

Users of the social network are given the ability to endorse products or services purchased or for which the user has special knowledge or information that can be useful to other users. For simplicity of description the term product endorsement is used in the description below as a representative term for endorsements of all kinds, but it should be understood that endorsements for service provides and other items such as movies, brand names, insurance, banking, etc. can also be included in the different embodiments of the invention.

In the example shown in FIG. 2, user 206 endorses products P1 and P2, user 204 endorses products P3 and P2, product P1 is endorsed by users 206, 202, and 208, etc. Assuming that all users have configured their endorsements to be seen only by their direct friends, and that all users have configured their user interface to show endorsements from their direct friends, then user 202 would see endorsements of P1 and P2 by user 206, endorsements of P2 and P3 by user 204, endorsement P1 by user 208, and endorsements P4 and P5 by user 212. However, user 202 would not see endorsements P6 and P7 by user 218 for two reasons: first, because user 202 only wishes to see endorsements by direct friends, and second, because user 218 does not want users beyond her friends to see her endorsements.

Endorsements constitute a very relevant way of product advertising, as endorsements provide a high level of reliability due to the fact that products are sponsored by people known (or at least related) to the user. In the case where users browse endorsements beyond their direct social network, a high level of reliability can also be achieved if a particular product has been sponsored by a large number of users. Products with a small number of recommendations by unknown users are not perceived as reliable, and the product recommendations can easily be subject to fraud, by either the product sponsor or by competitors of the product sponsor that wish to discredit the product. Product reviews abound in the Internet, but the reviews are as not reliable as they are often written by unknown entities, or by known entities that may have hidden financial or social interests in sponsoring the product.

Because of the additional reliability, endorsements are a great form of marketing and product sponsors are willing to pay for this form of advertising and promotion. The different entities that are interested in selling a product are referred to as product sponsors, which can include the product maker, distributors, retailers, auctioneers, related-product sponsor (such as a game for a game console seller), etc. Sponsors compensate social network providers for providing the infrastructure for the endorsements, as well as compensating the users that endorse their products. Product sponsorships and endorsements in social networks enable matching content provided by users with actual advertising needs from advertisers. In general, sponsoring and endorsing denote similar meanings, and herein we generally use the term sponsor for the advertiser and endorser for the user that wishes to offer information about a product, but they may also be used for either purpose at times.

Endorsements can be very valuable, but users may not be inclined to spend time entering their endorsements into the system. This obstacle can be lowered by giving incentives to endorsers, providing easy user interfaces for adding and searching endorsements, propagating information about endorsements quickly and upon the control of the user, etc. An incentive compensates the user for providing the endorsement. Compensation can take many forms, such as paying the user when endorsements are presented to other users, sometimes referred to as impressions, when endorsements are “clicked” by another user, and when a user generates a conversion based on a sponsorship. A conversion refers to a two-operation process. The first operation consists of clicking on the endorsement, and the second operation refers to an actual purchase by the user. There can be an allowed maximum time between an initial click and a purchase, such as a month, although other time periods are also possible. Conversions require software on the ecommerce site to match a purchase with an initial click or visit to the site.

Different advertisers want different outcomes from product endorsements. For example, one advertiser may be more interested in brand name recognition and thus giving incentives for impressions, while other advertiser may be more interested in actual sales and having the propensity to give high rewards for conversions. Additionally, social network providers have an incentive to provide sponsorships by collecting revenue for the advertising of products and services.

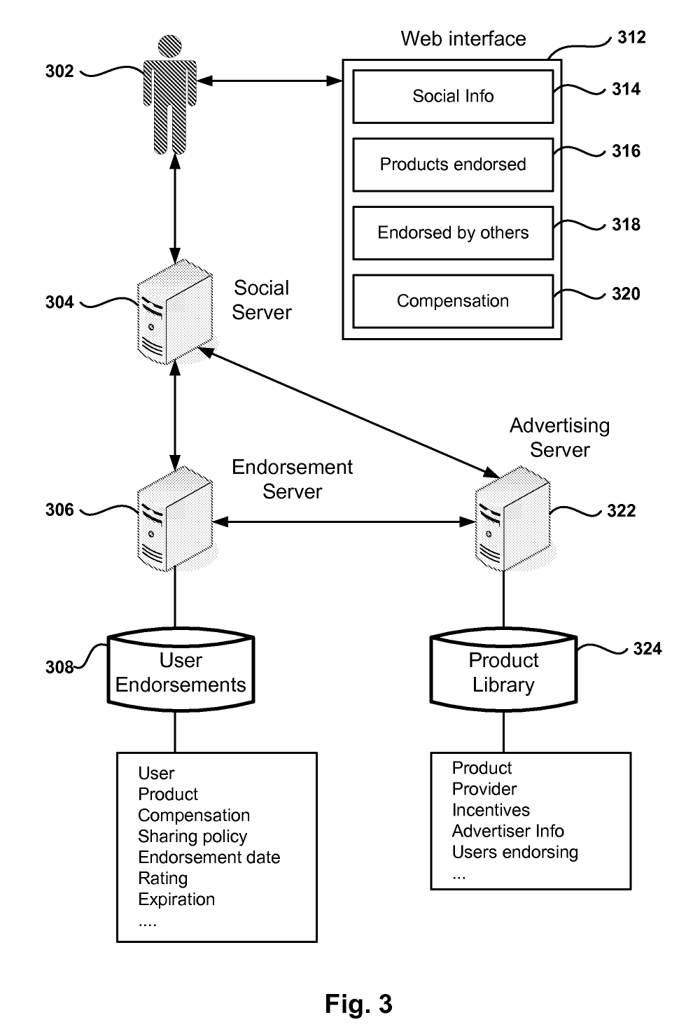

FIG. 3 depicts the relationships between the servers and the user, according to one embodiment. User 302 interacts with social server 304. Web interface 312 includes social information 314 related to the social network, products endorsed by the user 316, products endorsed by other users 318, compensation or incentives 320 accumulated by sponsorships of the user, etc. It should be understood that the user interface may include all the information aforementioned in one page, or available under pages linked to another pages in the social network interface or outside the social network. Additionally, one or more of these components of the user interface may be optional or not available for some users of the social network.

Advertising Server 322 and Endorsement Server 306 interact with Social Server 304 to provide product advertisements and manage the endorsement engine in the social site. Advertising server includes Product Library 324, which is a catalog of products and related information. Each product advertisement in the catalog describes a product or service. Product descriptions include the name of the product, a picture, a text description, information about the provider of the product/service, incentives for sponsors, etc.

When a product endorsement is clicked on by a user, the product advertisement redirects the user to another website containing more product information, such as Electronic Commerce Server 116 of FIG. 1. The click can be a billable event similar to sponsored search advertisements in search engines. Advertisers will pay, that is, provide incentives, for each click or conversion generated by an advertisement embedded inside a user's home page in the form of an endorsement.

Endorsement Server 306 keeps information regarding user endorsements 308. Each endorsement includes information regarding the user endorsing the product, compensation or incentive accrued by the user, the sharing policy for the endorsement with other users, the date the endorsement was made, a rating of the product, expiration date for the endorsement, etc. It should be understood that some of these values may be absent in a specific implementation while other embodiments may track additional information.

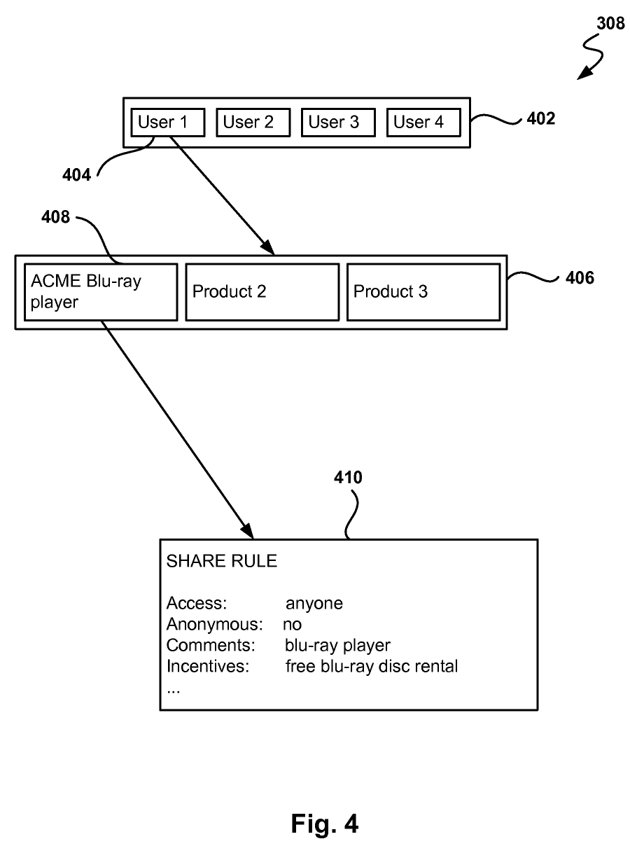

FIG. 4 depicts a simplified representation of an embodiment for data structures 308 used to share product endorsements. A list of users that have endorsed products is kept in list 402. For each, user a list of endorsed products is kept, such as list 406 including product endorsement 408 for User 1. In one embodiment, a link to an entry in product library 324 of FIG. 3 is kept for each of the products endorsed.

Each product endorsement includes sharing rules 410 configured by the user and the system. The sharing rule may indicate that the endorsement can be viewed universally within the social site, or only by friends, or by friends and friends and associates (such as direct friends), or even be viewed universally outside the social network. For example, products endorsements could be shown in an external blogging site.

It should be appreciated that the embodiments illustrated in FIG. 4 are exemplary data structures for managing endorsements. Other embodiments may utilize different fields, or may arrange the data in varying manners. The embodiments illustrated in FIG. 4 should therefore not be interpreted to be exclusive or limiting, but rather exemplary or illustrative.

In one embodiment, the system is dedicated only to “positive” endorsements, where users only generates endorsements when the users are satisfied with the product to let others know of a quality product. Advertisers wish to ride the wave of positive marketing by paying for the advertisement placement and by giving incentives to users providing incentives.

In another embodiment, the system allows “positive” and “negative” endorsements. A rating can be added by to each product showing whether the user is satisfied or dissatisfied with the product. Obviously, an advertiser would not want to sponsor negative endorsements, but there may be others, such as competitors, that would be interested. Additionally, a system where positive and negative comments are allowed provides a higher level of trust to users considering purchases because negative comments are not filtered by the system and offering an apparently fairer system.

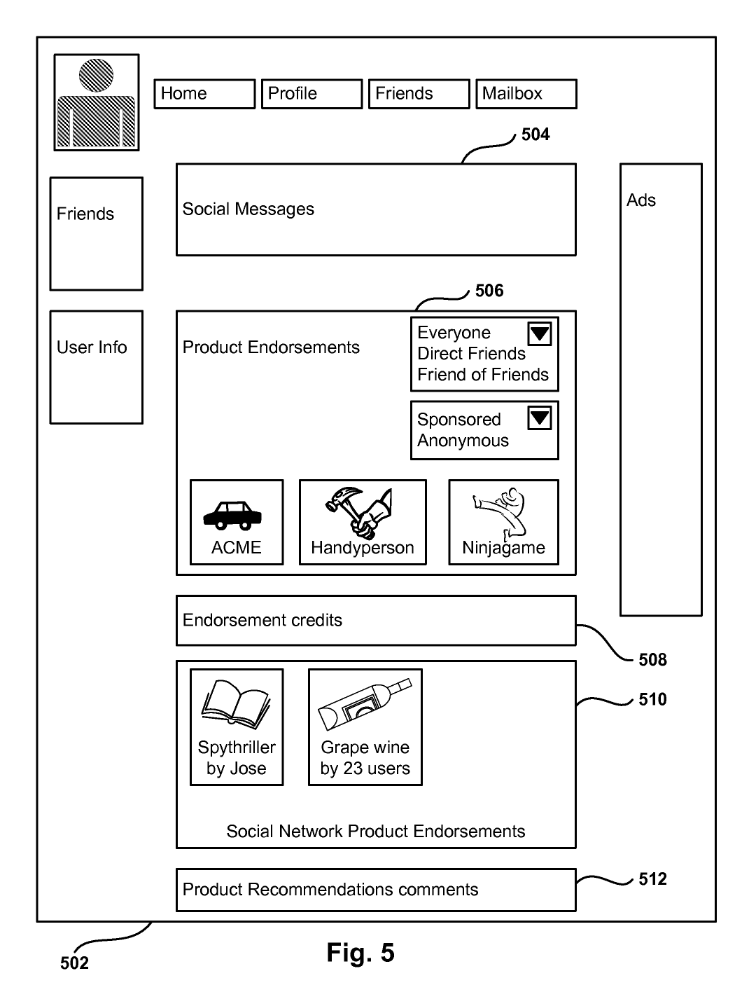

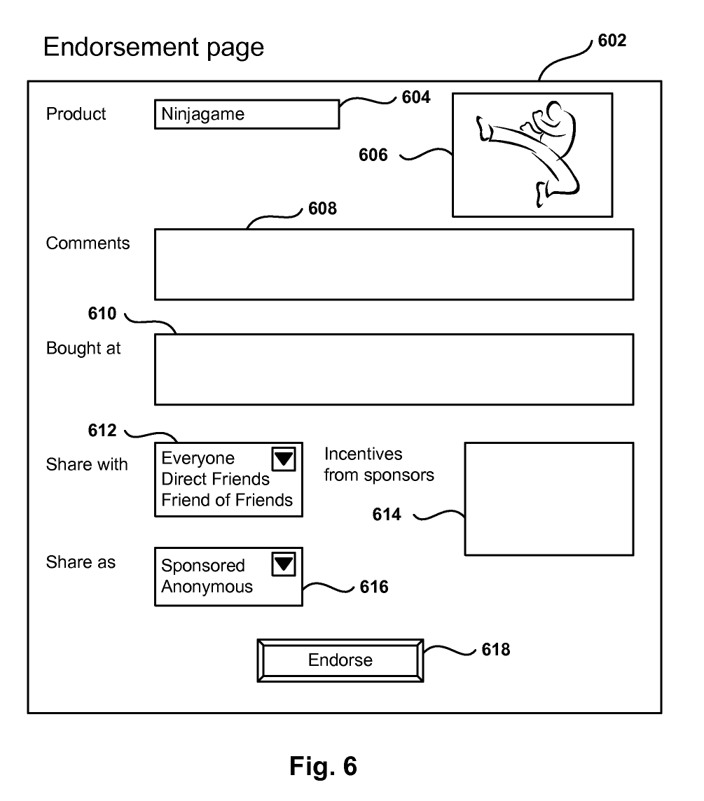

FIG. 5 is a pictorial representation of user web page 502 that includes product and service provider endorsements, according to one embodiment. Social Messages area 504 includes messages exchanged between a user and the user's friends. Product Endorsements area 506 contains products endorsed by the user as well as a mechanism to add, delete, or change product endorsements. A product is endorsed by selecting a product advertisement from the library and adding the product to product endorsement area 506, also referred to herein as the content area. The content area is a public space which can be viewed by other users of the social networking website. Other users are not allowed to add product endorsements to another user's content area. A sample user interface for managing product endorsements is described below in reference to FIG. 6.

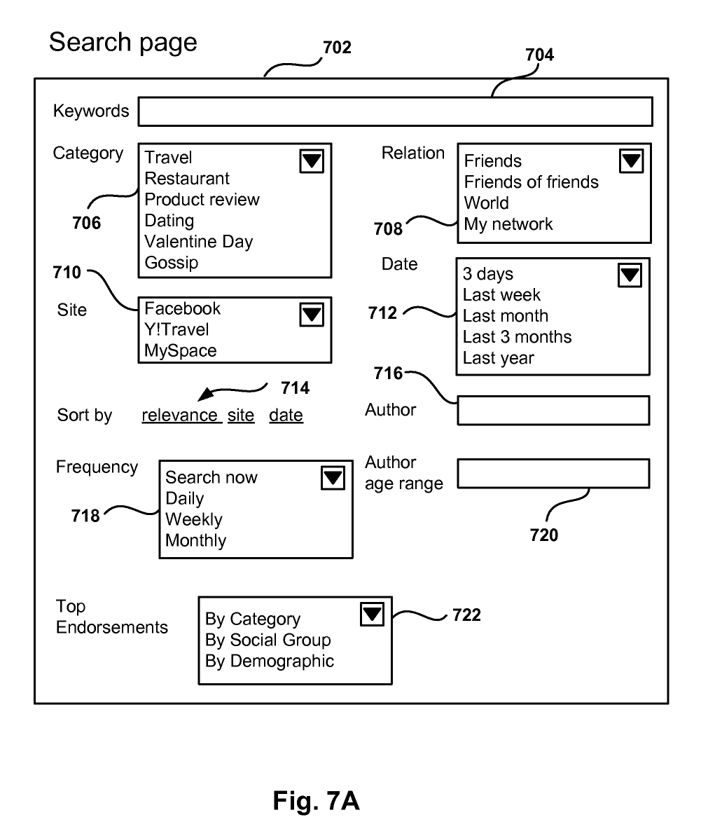

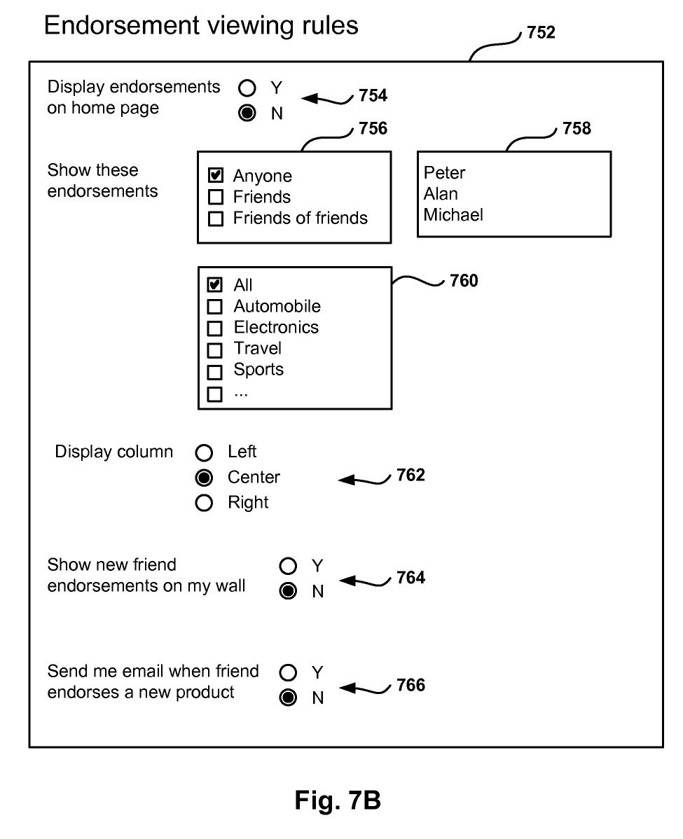

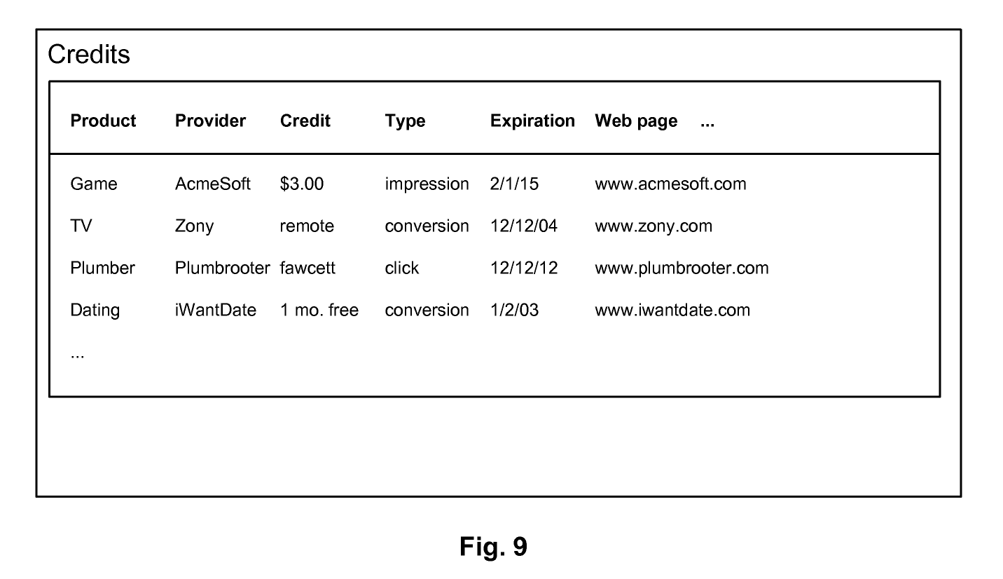

The credits or incentives accumulated by a user for endorsing products is shown in Endorsement credits area 508. A sample user interface is discussed below in reference to FIG. 9. In one embodiment, a link to a different page to display the information is provided. Product Endorsements by other users are displayed in area 510, which includes a list of products indicating sponsors and endorsers, or the number of endorsers, comments 512, etc. The user can choose whether to view the most popular product endorsements from within the social network, endorsements from friends and associates, endorsements from a selected friend, etc. Users may also use a search function to look for specific endorsements as described below in reference to FIG. 7A.

In another embodiment, product endorsements can also create messages between users. For example, if a social network includes a message exchange mechanism, such as a “wall” that shows the messages between two users, a user creating and endorsement may select that the system sends a message to friends indicating the new endorsement. For example, a message may be send to other user such as “Charles has endorsed the movie ‘Friday the 14^{th},’ Charles said: ‘Very funny! A must see.’” Additionally, users may choose to receive endorsements or block them as part of their messaging with friends.

When a user clicks in one of the products endorsed, the user will be redirected to another page or another website associated with the product. In some cases, the clicks on the ads may be made with fraudulent purposes to generate illicit revenue or drain advertiser budget. One embodiment provides a method to detect and eliminate fraudulent clicks, sometimes referred to as click-spam.

Since the identities of the users in the social network are known, clicking information can be tracked per user in order to detect click-spam and make click-spam not billable to advertisers. Tracking can be made by user id or via internet cookies. On social networking websites that require users to register before they can view home pages of other users, it is possible to track the number of times a particular user clicks on a particular advertisement. Clicks on advertisements will be considered fraudulent when the user shows an unusual clicking pattern, such as clicking on the same advertisement 25 times.

FIG. 6 shows user interface 602 for making endorsements, according to one embodiment. Once a user selects a product to endorse, an endorsement page 602 provides the interface for defining parameters associated with the endorsement. Product name is displayed in box 604, and an icon such as a picture or a photo is shown in box 606. Users can optionally enter comments in box 608, such as a description of why the user endorses the product. The place of purchase can be entered in box 610.

With drop-down menu 612, users can select which users can have access to the endorsement, such as everyone, direct friends, friends of friends, social groups linked to the user, selected demographics, etc. Users can select one or more options. Drop-down menu 616 allows a user to share the endorsement anonymously or using the user's identification. In box 614, a description of the incentives provided by the product sponsor or advertiser is provided. As previously discussed, the incentive motivates users to place product endorsements in their content area. Each user is a publisher providing content (photos, life updates, etc) relevant to their network of friends and associates. Treating users like publishers, each user can earn different benefits, such as a percentage of the revenue generated when other users click on product endorsements within their content area. Alternatively, each user can earn a percentage of revenue when another user completes a conversion after clicking on a product endorsement.

Incentives often are monetary, but other incentives are also possible, such as airline miles, coupons (discounted goods), free products (a watch), a service (free oil change, free meal), promotion of the user (privileged display in a dating site), notoriety (fan of the month in the promoter's website), etc.

Once all the information has been entered, the user clicks on button 618 to submit the information to the system and enter the endorsement in the database.

FIG. 7A depicts search user interface 702, according to one embodiment. Box 704 allows a user to specify keywords to be used in the search. The keywords may refer to product name, product maker, product category, name of the user sponsoring product, name of a group to select sponsors from within the group, etc. The keyword field may be left blank and parameters from other fields in search page 702 will be used in the search. Other input fields allow the user to further define the search. A category can be specified in box 706. The list of categories is typically managed by the system, but an option for adding new categories by the user is also available.

The user universe for the search can be specified in box 708, such as direct friends, expanded network of friends, everybody, the social site, etc. Box 710 allows a user to search in other sites, such as other social networks. Input box 712 allows the user to limit the search results to endorsements generated during certain dates, such as last 3 days, last week, last month, etc. The users also have an option to enter the beginning and the end date (not shown).

Sorting choices 714 specify the sort order for the result, such as sorting according to relevance (system determines the relevance according to the search criteria), web site, date, price, etc. Box 716 allows defining an author of the endorsement. The input can be done using wildcards (such as ‘John*’ to select all users with first name John) and can also include the name of a social group to search for users within the social group.

The search frequency can be specified in box 718. A user can set periodic searches for endorsements and then be notified via the social site home page, an email, etc. Age or age range (e.g. ‘20-30’) of the endorser can be specified in box 720. Box 722 enables the user to select the most popular endorsements by category, social group, demographic, etc. Examples of demographics include age group, ethnicity, income range, geographic location, employer, etc.

It should be noted that search parameters are optional, and the user can choose to specify zero or more parameters. When more than one parameter is chosen, the results are obtained by applying all the parameters, or in other words, performing a logical AND operation for all the filters associated with the search parameters. As a result, the more parameters defined, the narrower the search will be. In another embodiment, a user is allowed to combine parameters by performing a logical OR operation of the different filters. For example, a user may wish to search for endorsements from ‘my friends’ or ‘from church.’

FIG. 7B depicts an embodiment of user interface 752 for viewing endorsements. The user can select whether to display endorsements or not via radio buttons 754. Additionally, the user can select whether to view endorsements from anyone, friends, extended social network, etc., via checkbox 756. More specificity can be provided in box 758 by adding names of specific friends. Categories of the products endorsed can be selected in checkbox 760.

Other displaying options include the location on the user home page where endorsements can be seen, such as selecting the column (left, center, or right) with radio buttons 762. Radio buttons 764 allows the user to specify if she wants to be notified about new products endorsements via standard message exchange mechanisms in the social network. Radio buttons 766 allow the user to be notified via email when a friend creates a new endorsement.

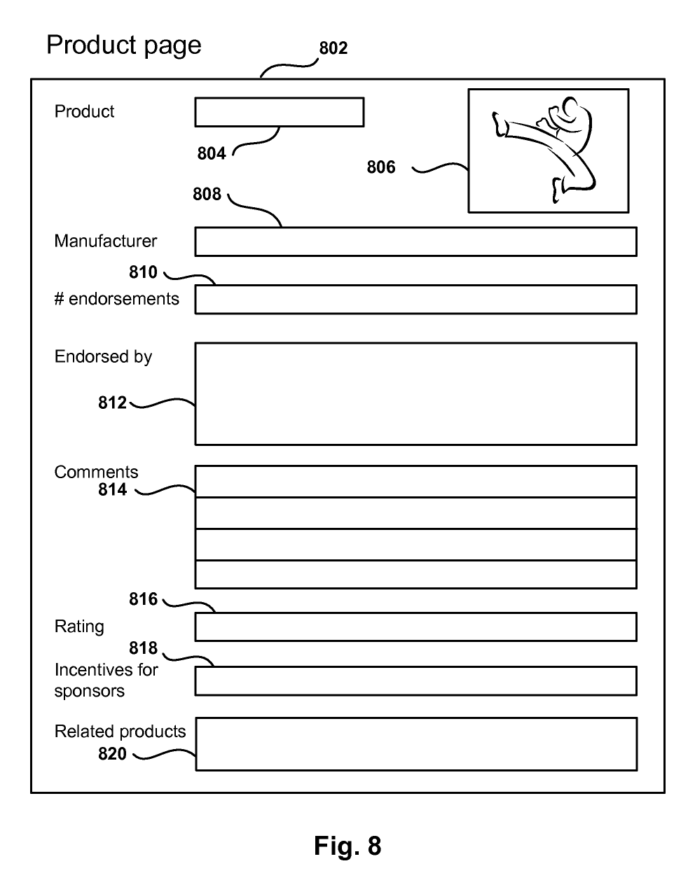

FIG. 8 illustrates a product endorsement page in accordance with one embodiment of the invention. When a user desires more information about a product in the library, product page 802 shows the user more information about the chosen product. The product name is shown in box 804 and a related picture or icon is shown in box 806. The manufacturer (or service provider) is shown in box 808, which can also include additional information besides the manufacturer, such as a distributor or list of distributors. The number of endorsers is displayed in box 810, where different statistical information can be shown, such as the total number of endorsers in the social network, number of friends endorsing, etc.

Information about the endorsers is shown in box 812, where a list of endorsers can be shown in whole or in part if the number of endorsers is large. When the number of endorsers is large, the listing all the endorsers would require a large amount of space in product page 802 (e.g., more than 100, but other values are also possible.). In this case an option to display a few endorsers and the ability to display more endorsers is provided, such as a scrolling option to display multiple pages of endorsers. Comments from the endorsers can be seen in box 814. In another embodiment, boxes 812 and 814 are combined and the comments are displayed next to each endorser when available.

Ratings are shown in box 816, which may also include statistical information. Incentives offered by the product manufacturer or sponsor are shown in box 818. Other related products are shown in box 820. Related products may include products offered by same manufacturer, or products often purchased with the product in box 804, or competing products, etc.

FIG. 9 shows a page of the user interface for displaying accumulated incentives, according to one embodiment. This play is available to the user that wants detailed information on incentives accrued by the user. In one embodiment, only credits available but not used are shown, and in another embodiment, all incentives are shown indicating that the incentives have been used or spent (“cashed”), or that the gained incentive credits are still available for redemption by the user.

It should be appreciated that the embodiments for user interfaces illustrated in FIGS. 5-9 are exemplary user interfaces for product endorsements. Other embodiments may utilize different fields, or may arrange the data in varying manners. Additionally, input methods for the different fields can be changed to allow the user a different way of input. For example, a pull-down menu can be changed to a multiple choice box, etc. The embodiments illustrated in FIGS. 5-9 should therefore not be interpreted to be exclusive or limiting, but rather exemplary or illustrative.

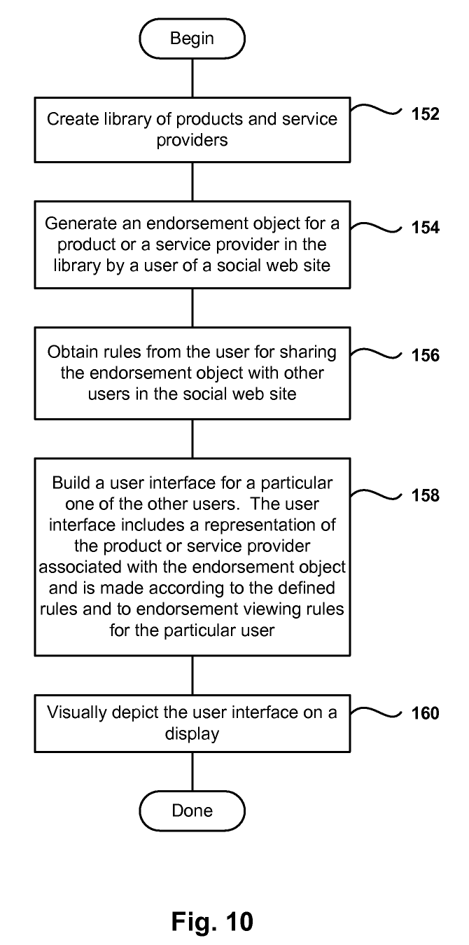

FIG. 10 shows the flow of an algorithm for creating a web user interface in accordance with one embodiment of the invention. In operation 152, a library of products and service providers is created, such as product library 324 of FIG. 3. The method generates an endorsement object for a product or a service provider in the library in operation 154. The endorsement object is generated by a user of a social web site, such as users 123-125 of FIG. 1 belonging to social web site hosted by Social Network Server 114.

In operation 156, rules from the user are obtained for sharing the endorsement object with other users in the social web site, such as rules selected in boxes 612 and 616 of FIG. 6. A user interface for a particular one of the other users is built in operation 158. The user interface includes a representation of the product or service provider associated with the endorsement object, where the representation is made according to the defined rules and to endorsement viewing rules set by the particular user. Sample embodiments of user interfaces are shown in FIGS. 5-9. In operation 160, the method visually depicts the user interface on a display.

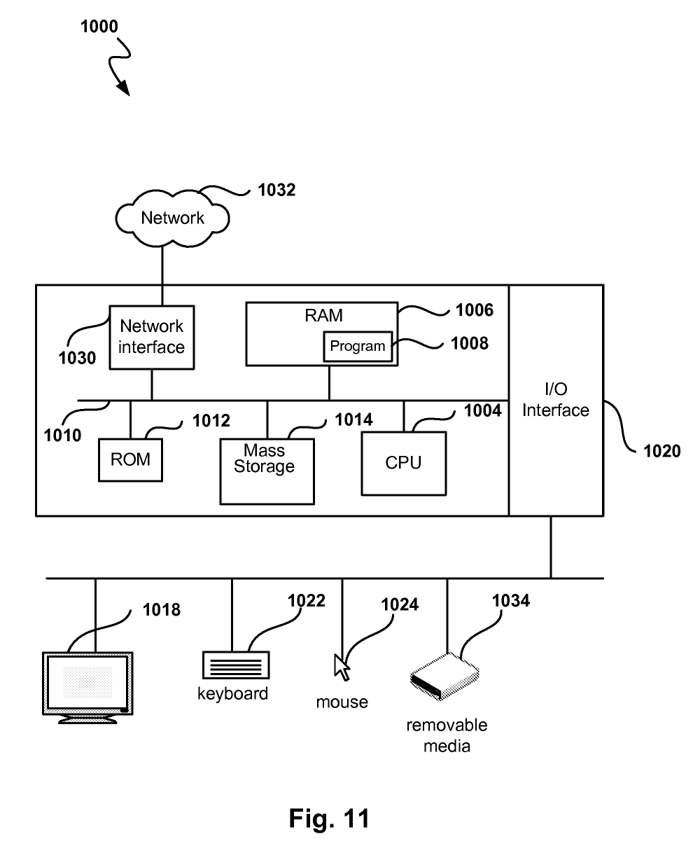

FIG. 11 is a simplified schematic diagram of a computer system for implementing embodiments of the present invention. It should be appreciated that the methods described herein may be performed with a digital processing system, such as a conventional, general-purpose computer system. Special purpose computers, which are designed or programmed to perform only one function may be used in the alternative. The computer system includes a central processing unit (CPU) 1004, which is coupled through bus 1010 to random access memory (RAM) 1006, read-only memory (ROM) 1012, and mass storage device 1014. User interface generating program 1008 resides in random access memory (RAM) 1006, but can also reside in mass storage 1014.

Mass storage device 1014 represents a persistent data storage device such as a floppy disc drive or a fixed disc drive, which may be local or remote. Network interface 1030 provides connections via network 1032, allowing communications with other devices, as seen in FIG. 1. It should be appreciated that CPU 1004 may be embodied in a general-purpose processor, a special purpose processor, or a specially programmed logic device. Input/Output (I/O) interface provides communication with different peripherals and is connected with CPU 1004, RAM 1006, ROM 1012, and mass storage device 1014, through bus 1010. Sample peripherals include display 1018, keyboard 1022, cursor control 1024, removable media device 1034, etc.

Display 1018 is configured to display the user interfaces described herein, such as browser 134 from FIG. 1. Keyboard 1022, cursor control 1024, removable media device 1034, and other peripherals are coupled to I/O interface 1020 in order to communicate information in command selections to CPU 1004. It should be appreciated that data to and from external devices may be communicated through I/O interface 1020. The invention can also be practiced in distributed computing environments where tasks are performed by remote processing devices that are linked through a wire-based or wireless network.

With the above embodiments in mind, it should be understood that the invention can employ various computer-implemented operations involving data stored in computer systems. These operations are those requiring physical manipulation of physical quantities. Any of the operations described herein that form part of the invention are useful machine operations. The invention also relates to a device or an apparatus for performing these operations. In one embodiment, the apparatus can be specially constructed for the required purpose (e.g. a special purpose machine), or the apparatus can be a general-purpose computer selectively activated or configured by a computer program stored in the computer. In particular, various general-purpose machines can be used with computer programs written in accordance with the teachings herein, or it may be more convenient to construct a more specialized apparatus to perform the required operations.

The invention can also be embodied as computer readable code on a computer readable medium. The computer readable medium is any data storage device that can store data, which can be thereafter be read by a computer system. Examples of the computer readable medium include hard drives, network attached storage (NAS), read-only memory, random-access memory, CD-ROMs, CD-Rs, CD-RWs, magnetic tapes and other optical and non-optical data storage devices. The computer readable medium can include computer readable tangible medium distributed over a network-coupled computer system so that the computer readable code is stored and executed in a distributed fashion.

Although the method operations were described in a specific order, it should be understood that other housekeeping operations may be performed in between operations, or operations may be adjusted so that they occur at slightly different times, or may be distributed in a system which allows the occurrence of the processing operations at various intervals associated with the processing, as long as the processing of the overlay operations are performed in the desired way.

Although the foregoing invention has been described in some detail for purposes of clarity of understanding, it will be apparent that certain changes and modifications can be practiced within the scope of the appended claims. Accordingly, the present embodiments are to be considered as illustrative and not restrictive, and the invention is not to be limited to the details given herein, but may be modified within the scope and equivalents of the appended claims.

What is claimed is:

1. A method for creating a web user interface, the method comprising:
creating a library of products and service providers;
generating an endorsement object for a product or a service provider in the library, the endorsement object being generated by a user of a social web site;
obtaining rules from the user for sharing the endorsement object with other users in the social web site;
building a user interface for a particular one of the other users, the user interface including a representation of the product or service provider associated with the endorsement object, the representation being made according to the defined rules and to endorsement viewing rules for the particular user; and
visually depicting the user interface on a display.

2. The method as recited in claim 1, wherein creating a library further includes,
receiving a subscription request from a product or service provider sponsor;
receiving promotional policies from the sponsor for placing endorsements in the social web site; and
receiving incentive policies for users endorsing the product or service provider associated with the subscription request.

3. The method as recited in claim 2, wherein the subscription request can be generated exclusively by an owner of the product or the service provider.

4. The method as recited in claim 2, wherein the subscription request can be generated by any sponsor, wherein one or more sponsors can sponsor a single product or service provider.

5. The method as recited in claim 2, wherein the promotional policies include fees paid by the sponsor to a social web site provider for at least one from the group consisting of existence in the library, a placement, a click, or a conversion.

6. The method as recited in claim 5 further including,
tracking user clicks on the representation of the product or service provider of the user interface to detect fraud.

7. The method as recited in claim 2, wherein the incentive policies includes incentives given to the user generating the endorsement for facilitating at least one from the group consisting of a placement, a click, or a conversion.

8. The method as recited in claim 2, wherein the incentive policies include rewarding the user generating the endorsement with at least one from the group consisting of an amount of money, points redeemable for goods and services, airline miles, a free service, a free product, a free membership, a referral, notoriety for the user, or a coupon.

9. The method as recited in claim 1, wherein creating a library is performed by one of a product sponsor, a service provider sponsor, or users of the social web site.

10. The method as recited in claim 1, wherein generating an endorsement object further includes,
searching the library to find a particular product,
entering a comment related to the particular product, and
endorsing the particular product.

11. The method as recited in claim 10, wherein generating an endorsement object further includes,
indicating where the particular product was purchased, and
indicating a price paid for the particular product.

12. The method as recited in claim 10, wherein generating an endorsement object further includes,
adding a rating for the product.

13. A system for creating a web user interface promoting products or service providers, the system comprising:
a social web server;
an advertising server containing a library of products and service providers; and
an endorsement server containing endorsement objects for product and service providers in the library, the endorsement objects being generated by users of a social web site, the endorsement objects including rules for sharing the endorsement object with other users;
wherein the social web server includes a user interface for a particular user that includes a representation of a particular product or service provider associated with a particular endorsement object, the representation being made according to the rules for sharing and to endorsement viewing rules for the particular user;
wherein the user interface is visually depicted on a display.

14. The system of claim 13, wherein the rules for sharing include options selected from the group consisting of direct friends, friends of friends, universal sharing.

15. The system of claim 13, wherein the rules for sharing include an option for sharing anonymously or sharing showing identification of a user that generated the particular endorsement.

16. The system of claim 13, wherein the user interface further includes an option to show which users endorse a particular product.

17. The system of claim 13, wherein the user interface further includes an option to show which products and service providers are endorsed by an identified user.

18. The system of claim 13, wherein the user interface further includes an option to display incentives collected by a user of the social web site.

19. A computer program embedded in a computer-readable storage medium, when executed by one or more processors, for creating a web user interface, the computer program comprising:
program instructions for creating a library of products and service providers;
program instructions for generating an endorsement object for a product or a service provider in the library, the endorsement object being generated by a user of a social web site;
program instructions for obtaining rules from the user for sharing the endorsement object with other users in the social web site;
program instructions for building a user interface for a particular one of the other users, the user interface including a representation of the product or service provider associated with the endorsement object, the representation being made according to the defined rules and to endorsement viewing rules for the particular user; and
program instructions for visually depicting the user interface on a display.

20. The computer program as recited in claim 19, wherein the program instructions for building a user interface further include,
program instructions for receiving a specification from the particular user on how to place the representation of the product or service provider.

21. The computer program as recited in claim 19, wherein the representation further includes,
a product or service provider name,
a name of the product or service provider, and
a website for the product or service provider.

22. The computer program as recited in claim 21, wherein the representation further includes,
users endorsing the product or service provider.

23. The computer program as recited in claim 19 further including,
program instructions for collecting a fee from a sponsor of the product or service provider endorsement object after visually depicting the user interface, and
program instructions for collecting an incentive by the user that generated the endorsement object after visually depicting the user interface.

24. The computer program as recited in claim 19, wherein the representation of the product or service provider includes different presentation options corresponding to payment options by a sponsor of the product or service provider endorsement object.

25. The computer program as recited in claim 19 further including,
program instructions for notifying the user that generated the endorsement object after visually depicting the user interface to the particular user.

26. The computer program as recited in claim 19 further including,
program instructions for presenting an external user interface including a representation of the product or service provider associated with the endorsement object, and
program instructions for visually depicting the external user interface on a web page outside the social web site.
